(19) United States
(12) Patent Application Publication
(10) Pub. No.: US 2025/0167894 A1
(43) Pub. Date: May 22, 2025

(54) OPTICAL TRANSMISSION DEVICE

(71) Applicant: Fujitsu Limited, Kawasaki-shi (JP)

(72) Inventors: Junichi SUGIYAMA, Kawasaki (JP); Hiroki NAGATA, Fukuoka (JP); Yuma KIMURA, Yokohama (JP); Jiro TAKEZAWA, Kawasaki (JP)

(73) Assignee: Fujitsu Limited, Kawasaki-shi (JP)

(21) Appl. No.: 18/926,492

(22) Filed: Oct. 25, 2024

(30) Foreign Application Priority Data
Nov. 17, 2023 (JP) 2023-195566

(51) Int. Cl. H04B 10/40; H04B 10/27; H04L 1/00

(52) U.S. Cl. CPC H04B 10/40; H04B 10/27; H04L 1/0041

(57) ABSTRACT

Optical transmission device includes: a reception unit, a detector, a mapping unit and a transmission unit. The reception unit receives a first signal transmitted based on a first clock. The detector detects rate information for storing client data in the first signal in a transmission frame based on the first signal. The mapping unit generates the transmission frame by mapping the client data to a payload area of the transmission frame based on the rate information. The transmission unit outputs the transmission frame or a second transmission frame including the transmission frame to a network. The reception unit, the detector, and the transmission unit are implemented by a hardware circuit, and the mapping unit is implemented by software processing using a processor.

### CROSS-REFERENCE TO RELATED APPLICATION

This application is based upon and claims the benefit of priority of the prior Japanese Patent Application No. 2023-195566, filed on Nov. 17, 2023, the entire contents of which are incorporated herein by reference.

### FIELD

The embodiments discussed herein are related to an optical transmission device that transmits a frame.

### BACKGROUND

An optical transport network (OTN) has been widely used as one of technologies for realizing large-capacity communication. The OTN stores and transmits various speeds or various types of client signals in an OTN frame. Therefore, according to the OTN, the network can be flexibly configured. However, a frequency of a clock of the OTN network may be different from a frequency of a clock of a client signal. Accordingly, the optical transmission device provided between a client-side network and an OTN network has a function of converting (or replacement) a clock.

For example, when a client signal is received from a client, the optical transmission device extracts client data from the received client signal and stores the client data in a first-in first-out (FIFO) memory. The optical transmission device reads the client data from the FIFO memory based on a clock on the OTN network. Then, the optical transmission device maps the client data read from the FIFO memory to a payload area of an optical channel transport unit (OTU) frame while absorbing a frequency difference or a phase difference between an OTN clock and a client clock.

During this process, the optical transmission device generates a Cm value representing a data amount of client data mapped to a payload and a Cnd value that is a value obtained by adding an increase or decrease amount of data within a given period of time. The Cm value and the Cnd value are stored in an overhead of an OTU frame. Then, the optical transmission device transmits the OTU frame to an optical transmission device provided in a correspondent station via the OTN network. Hereinafter, the correspondent station may be referred to as a remote station or a remote node.

The remote station device extracts the client data from the received OTU frame and stores the client data in a FIFO memory. The remote station device extracts a Cm value and a Cnd value from the received OTU frame and calculates a Cn value based on the extracted Cm value and Cnd value. Further, the remote station device recovers the OTN clock from a received signal, and reproduces a client clock used by a source station (that is, client) by using the recovered OTN clock, Cm value, and Cn value. Then, the remote station device reads the client data from the FIFO memory based on the reproduced client clock and forwards the client data to a destination.

The above-described optical transmission device is required to operate at a high speed. For example, in a process of replacing a clock, an ultrahigh-speed operation is required. Therefore, in an optical transmission device of the prior art supporting an OTN, a function of processing a main signal is implemented with a hardware circuit such as a field programmable gate array (FPGA) or an application specific standard produce (ASSP).

A configuration that causes a clock reproduced from an OTU frame to follow a clock of a client is described in, for example, Japanese Laid-Open Patent Publication No. 2016-163275.

As described above, the function of processing the main signal in the optical transmission device is often implemented with a hardware circuit such as FPGA or ASSP from the viewpoint of a high-speed operation. However, for the FPGA or the ASSP, it is not easy to change design. Therefore, for example, in a case where a new communication service is introduced or a case where a communication service is changed, there is concern of a large cost and a long time being required for development of a hardware circuit. This problem may also occur at the end of life (EOL) of an existing device.

The above-described risk may be reduced by adopting a configuration that processes a main signal using a general-purpose central processing unit (CPU). However, since the CPU is configured to read and execute a command, the CPU is not appropriate for high-speed signal processing.

Accordingly, for example, when the main signal is processed using the general-purpose CPU in an optical transmission device supporting an OTN, there is concern that accuracy of clock reproduction may deteriorate, and thus communication quality may deteriorate.

### SUMMARY

According to an aspect of the embodiments, an optical transmission device includes: a: reception unit configured to receive a first signal transmitted based on a first clock; a detector configured to detect rate information for storing client data in the first signal in a transmission frame based on the first signal; a mapping unit configured to generate the transmission frame by mapping the client data to a payload area of the transmission frame based on the rate information; and a transmission unit configured to output the transmission frame or a second transmission frame including the transmission frame to a network. The reception unit, the detector, and the transmission unit are implemented by a hardware circuit, and the mapping unit is implemented by software processing using a processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical transmission system according to an embodiment of the present disclosure;

FIG. 2 illustrates an example of a circuit that processes a main signal in the optical transmission device;

FIGS. 3A to 3C illustrate frame structure of OTN;

FIG. 4 illustrates an example of a configuration in which client data is stored in a frame and output to a network in the optical transmission device according to the embodiment;

FIG. 5 illustrates an example of a rate information detector;

FIG. 6 illustrates an example of a mapping operation by a CPU;

FIGS. 7A and 7B illustrate examples of timing charts of frame generation;

FIG. 8 is a sequence diagram illustrating an example of a procedure of generating an OTN frame for transmitting client data;

FIG. 9 illustrates an example of a configuration in which client data is extracted from an OTN signal and transmitted to a destination client in the optical transmission device according to the embodiment;

FIG. 10 illustrates an example of a procedure of extracting client data from an OTN frame; and

FIG. 11 illustrates an advantage according to the embodiment of the disclosure.

### DESCRIPTION OF EMBODIMENTS

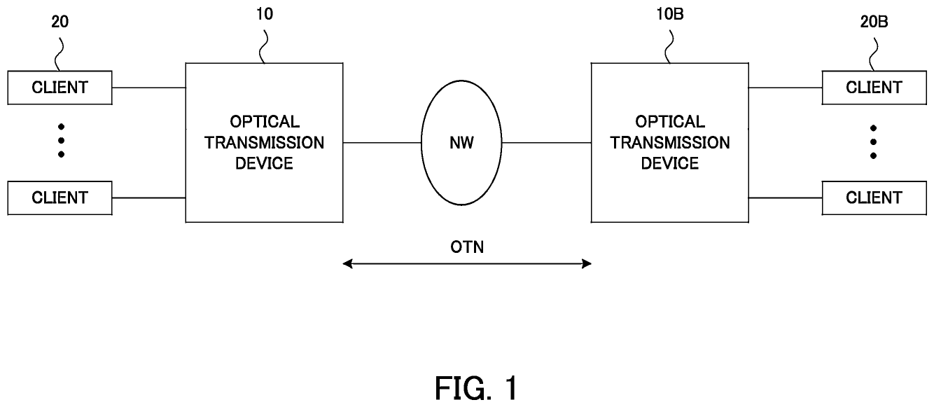

FIG. 1 illustrates an example of an optical transmission system according to an embodiment of the present disclosure. In the embodiment, the optical transmission system includes an optical transmission device 10 and an optical transmission device 10B. The optical transmission device 10 accommodates one or a plurality of clients 20, and the optical transmission device 10B accommodates one or a plurality of clients 20B.

The optical transmission device 10 stores a client signal output from the client 20 in an OTN frame. At this time, the optical transmission device 10 may multiplex a plurality of client signals output from the plurality of clients 20 and store the multiplexed client signals in the OTN frame.

The OTN frame generated by the optical transmission device 10 is transmitted via a network NW. In the embodiment, the optical transmission device 10B receives the OTN frame via the network NW. Then, the optical transmission device 10B extracts the client signal from the ON frame and forwards the client signal to the client 20B.

A frequency of a clock of the client signal and a frequency of a clock for transmitting the OTN frame are not the same. Therefore, the optical transmission devices 10 and 10B have a function of converting a clock. In the following description, the clock of the client signal may be referred to as a “CL clock”. A clock for transmitting the OTN frame may be referred to as an “NW clock”.

The optical transmission device 10 stores client data in the client signal in a FIFO memory. The optical transmission device 10 reads the client data from the FIFO memory based on the NW clock. Then, the optical transmission device 10 maps the client data read from the FIFO memory to a payload area of the OTU frame while absorbing a frequency difference or a phase difference between the CL clock and the NW clock.

At this time, the optical transmission device 10 generates a Cm value representing a data amount of client data mapped to the payload area, and a Cnd value that is a value obtained by adding an increase or decrease amount of data within a given period of time. The Cm value and the Cnd value are stored in an overhead of an OTU frame. The optical transmission device 10 transmits the OTU frame to the optical transmission device 10B via the network NW.

The optical transmission device 10B extracts the client data from the received OTU frame and stores the client data in a FIFO memory. The optical transmission device 10B extracts a Cm value and a Cnd value from the received OTU frame and calculates a Cn value based on the extracted Cm value and Cnd value. Further, the optical transmission device 10B recovers the NW clock from the received signal, and reproduces the CL clock used by the client 20 by using the recovered NW clock, Cm value, and Cn value. Then, the optical transmission device 10B reads the client data from the FIFO memory based on the reproduced CL clock and forwards the client data to a destination (that is, the client 20B).

The configurations of the optical transmission device 10 and the optical transmission device 10B are substantially the same. That is, the optical transmission device 10B can store the client signal generated by the client 20B in the OTN frame and transmit the OTN frame to the optical transmission device 10 can the network NW extract the client signal from the OTN frame received via the network NW and forward the extracted client signal to the destination.

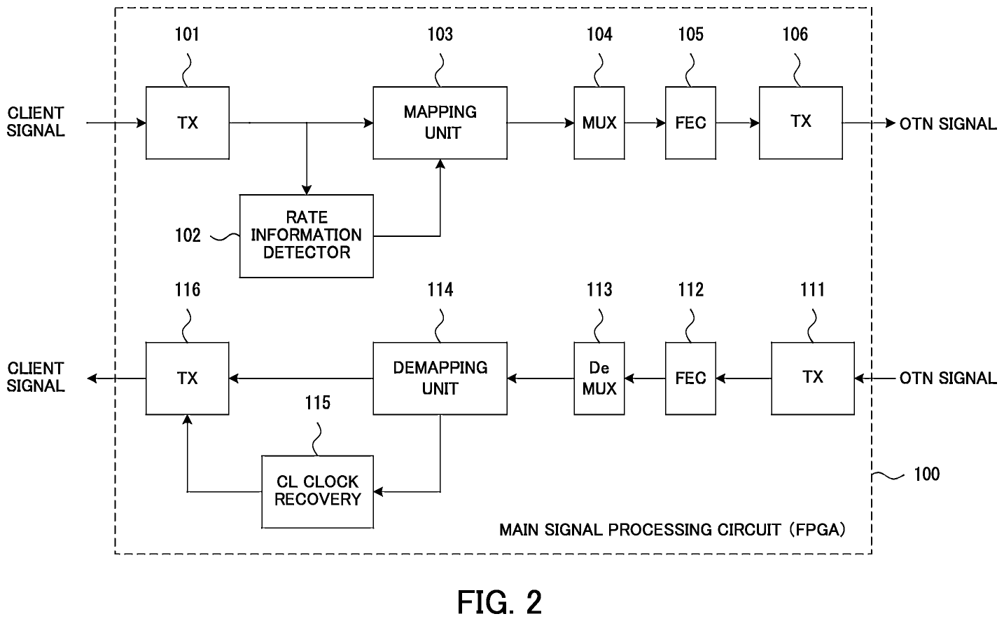

FIG. 2 illustrates an example of a circuit that processes a main signal in the optical transmission device (10 and 10B). In the embodiment, the main signal processing circuit 100 includes a reception unit 101, a rate information detector 102, a mapping unit 103, a multiplexer (MUX) 104, an FEC processor 105, a transmission unit 106, a reception unit 111, an FEC processor 112, a demultiplexer (DeMUX) 113, a demapping unit 114, a CL clock recovery 115, and a transmission unit 116. The optical transmission device includes an optical receiver that receives an optical signal and an optical transmitter that converts an electrical signal into an optical signal and transmits the optical signal, in addition to the main signal processing circuit 100. The optical transmission device includes s a processor that controls the main signal processing circuit 100.

The reception unit 101, the rate information detector 102, the mapping unit 103, the multiplexer 104, the FEC processor 105, and the transmission unit 106 store the client data in the OTN frame to transmit the client data to the network. The reception unit 111, the FEC processor 112, the demultiplexer 113, the demapping unit 114, the CL clock recovery 115, and the transmission unit 116 extract the client data from the OTN frame and forward the client data to the destination client.

The reception unit 101 receives a client signal transmitted from a client. The rate information detector 102 generates rate information based on the client signal received by the reception unit 101. The rate information includes a Cm value, a Cnd value, and a Cn value in the embodiment. The mapping unit 103 maps the client data in the client signal to the payload area of the ODU frame based on the rate information. In this process, the Cm value and the Cnd value are inserted into an overhead of the ODU frame.

The main signal processing circuit 100 illustrated in FIG. 2 can process a plurality of client signals in parallel. In this case, a plurality of sets of reception units 101 and mapping units 103 generate a plurality of ODU frames in parallel.

The multiplexer 104 multiplexes a plurality of ODU frames generated in parallel. That is, an HO ODU frame is generated from a plurality of LO_ODU frames. The FEC processor 105 applies an error correction code to the HO ODU frame. Accordingly, an OTUk frame is generated. Then, the transmission unit 106 outputs an OTN signal representing the OTUk frame to the network.

The reception unit 111 receives the OTN signal via the network and reproduces the OTUk frame. The FEC processor 112 performs an error correction process using the error correction code assigned to the OTUK frame. The demultiplexer 113 extracts a plurality of ODU frames from the OTUk frame. The demapping unit 114 extracts the client data from the payload area of the ODU frame. The demapping unit 114 extracts the Cm value and the Cnd value from the overhead of the ODU frame. The CL clock recovery 115 reproduces the CL clock based on the Cm value and the Cnd value extracted from the received frame. Then, the transmission unit 116 transmits the client data extracted from the received frame to a corresponding client by using the CL clock.

In the main signal processing circuit 100 that has the above configuration, the following processes require high-speed operation.
(1) A process of detecting the Cn Value, the Cm Value, and the Cnd Value in the rate information detector 102
(2) A multiplexing process in the multiplexer 104
(3) A demultiplexing process in the demultiplexer 113
(4) A process of reproducing a CL clock

Therefore, the main signal processing circuit 100 is preferably implemented with a hardware circuit. In this case, the hardware circuit is, for example, an FPGA. Here, when the entire main signal processing circuit 100 is implemented with a hardware circuit, as described above, a risk related to a change in design corresponding to a new communication service or an end of life (EOL) is large.

This risk may be reduced by adopting a configuration that processes the main signal using a general-purpose CPU. However, the CPU is not appropriate for high-speed signal processing. Accordingly, for example, when the main signal is processed using the general-purpose CPU in an optical transmission device supporting an OTN, there is concern that accuracy of clock reproduction may deteriorate, and thus communication quality may deteriorate.

Therefore, a main signal processing function of the optical transmission device according to the embodiment of the present disclosure is implemented with a hardware circuit and software processing in combination.

Specifically, for example, signal processing that does not depend on a communication service is implemented with a hardware circuit, and signal processing that depends on the communication service is implemented by software processing.

### EMBODIMENT

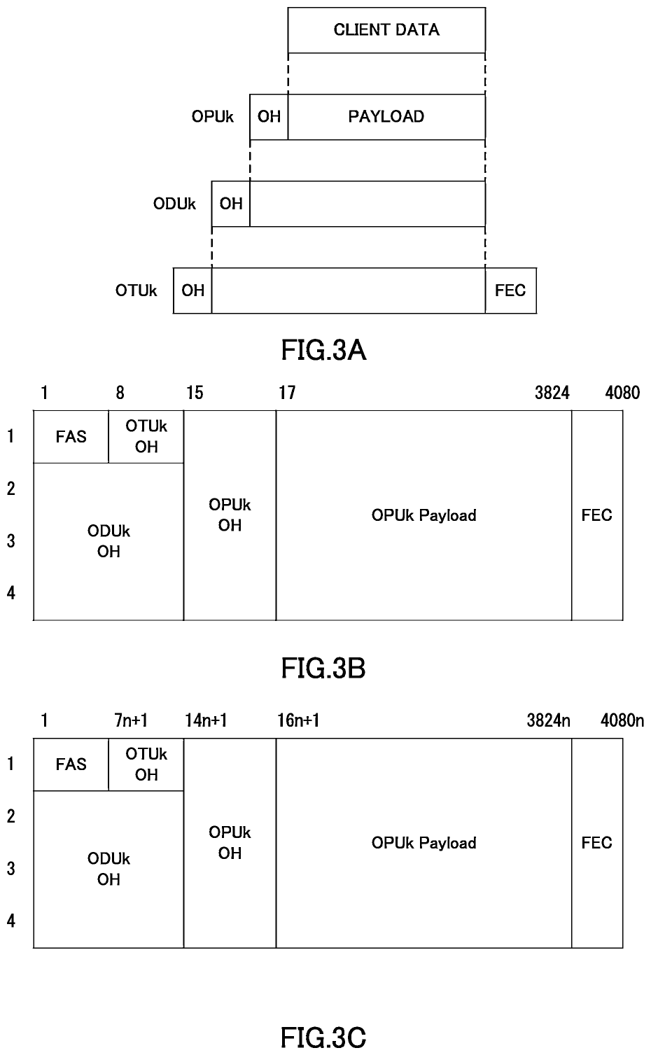

In an embodiment of the present disclosure, client data is stored in an OTN frame to be transmitted by the optical transmission device 10. In the OTN, the client data is accommodated in a payload of an optical channel payload unit-k (OPUk) frame, as illustrated in FIG. 3A. Here, k indicates a transmission rate. The OPUk frame has an OPU overhead. The OPUk frame is accommodated in a payload of an optical channel data unit-k (ODUk) frame. The ODUk frame has an ODU overhead. The ODUk frame is accommodated in a payload of an optical channel transport unit-k (OTUk) frame. The OTUk frame has an OTU overhead. An error correction code FEC is assigned to the OTUk frame. In the following description, the OPUk frame, the ODUk frame, and the OTUk frame may be referred to as “OTN frames” or simply “frames” without being distinguished from each other.

The OTUk frame configured as described above is a fixed-length frame. For example, the OTUk frame has the configuration illustrated in FIG. 3B.

In recent years, with an increase in speed of the client signal, an OTN (B100G: beyond 100 G) exceeding 100 Gbps has been discussed. In the B100G, not only large-capacity transmission but also flexibility is required. Therefore, as illustrated in FIG. 3C, an OTUCn frame in which n OTUC frames are multiplexed is defined. In ITU-T Recommendations G.709.1, a flexible OTN (FlexO) that multiplexes a plurality of physical interfaces is defined. A signal accommodated in the Flexo is, for example, an OTUCn.

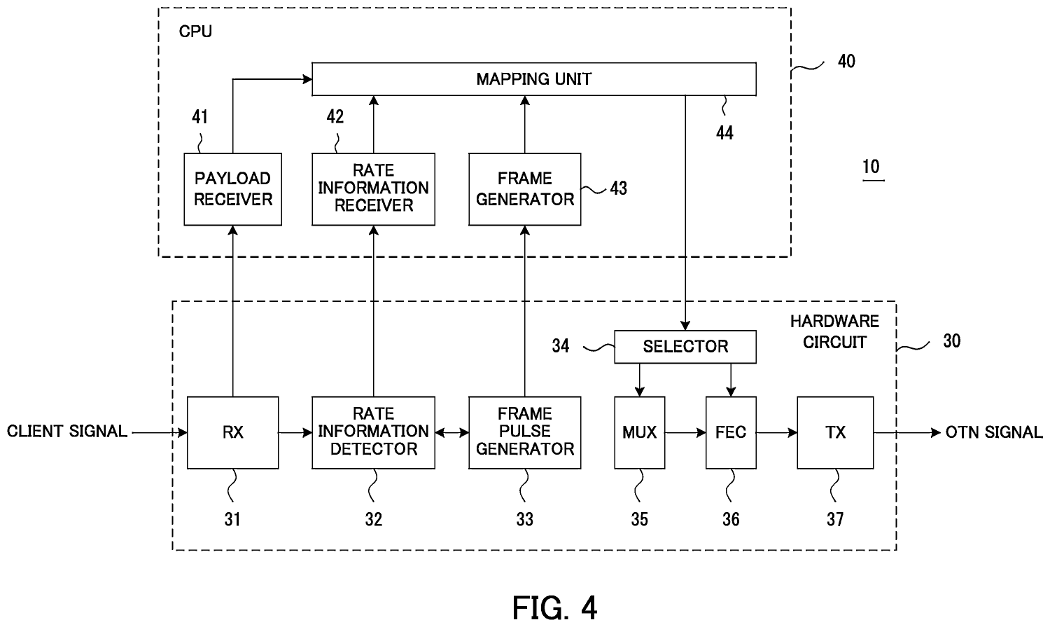

FIG. 4 illustrates an example of a configuration in which client data is stored in a frame and output to a network in the optical transmission device according to the embodiment. In the embodiment, the optical transmission device 10 includes a reception unit 31, a rate information detector 32, a frame pulse generator 33, a selector 34, a multiplexer (MUX) 35, an FEC processor 36, a transmission unit 37, a payload receiver 41, a rate information receiver 42, a frame generator 43, and a mapping unit 44 as a configuration that stores client data in a frame and outputs the frame data to a network. The optical transmission device 10 may further include other circuits, devices, or functions not illustrated in FIG. 4. For example, in FIG. 4, an optical receiver that receives an optical signal that transmits a client signal and an optical transmitter that generates an optical signal transmitted by an OTN signal are omitted.

The reception unit 31, the rate information detector 32, the frame pulse generator 33, the selector 34, the multiplexer 35, the FEC processor 36, and the transmission unit 37 are implemented by a hardware circuit 30. The hardware circuit 30 is implemented by, for example, an FPGA.

The reception unit 31 receives a client signal transmitted from a client. The client signal transmits client data generated by the client. The reception unit 31 extracts the client data from the client signal. The extracted client data is guided to the CPU 40 to be described below. The optical transmission device 10 may accommodate a plurality of clients. That is, although one reception unit 31 is illustrated in FIG. 4, the optical transmission device 10 may include a plurality of reception units 31. In this case, the optical transmission device 10 can receive a plurality of client signals.

The rate information detector 32 generates rate information based on the client signal received by the reception unit 31. The rate information includes a Cm value, a Cnd value, and a Cn value in the embodiment. The frame pulse generator 33 generates a frame pulse at a specified cycle. The frame pulse is generated, for example, by dividing a system clock generated in the optical transmission device 10. The frame clock can be used as a trigger signal for generating and transmitting a frame at the specified cycle.

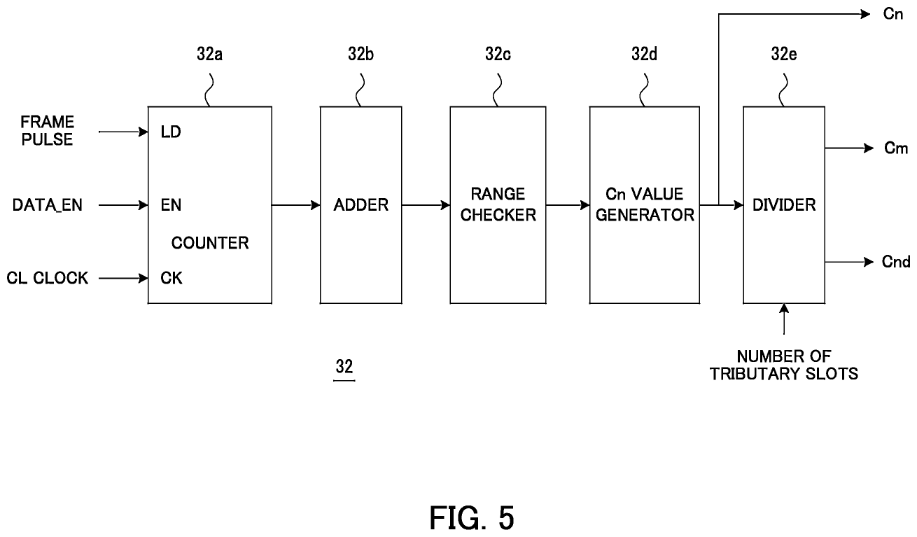

FIG. 5 is a diagram illustrating an example of the rate information detector 32. In the embodiment, the rate information detector 32 includes a counter 32a, an adder 32b, a range checker 32c, a Cn value generator 32d, and a divider 32e.

The counter 32a includes a load terminal (LD), an enable terminal (EN), and a clock terminal (CK). A frame pulse generated by the frame pulse generator 33 is input to the load terminal. A data enable signal (DATA EN) indicating presence or absence of the client data is input to the enable terminal. For example, when the client signal has client data, the data enable signal indicates an H state. When the client signal does not have the client data, the data enable signal indicates an L state. A CL clock extracted from the client signal is input to the clock terminal. The CL clock may be extracted by the reception unit 31 or may be extracted by a clock extraction circuit (not illustrated).

Here, the counter 32a counts the number of pulses input to the CK terminal during a period in which the enable terminal is in the H state. For example, when the load terminal changes from the H state to the L state, the counter 32a outputs a counter value and resets a counting operation. Accordingly, the counter 32a represents an amount of client data within the frame period.

The adder 32b adds or accumulates the counter values output from the counter 32a for a specified period. When a specified time has elapsed, the adder 32b outputs a value indicating an addition result. The range checker 32c determines whether the value output from the adder 32b falls within a specified range. When the value output from the adder 32b falls within the specified range, the range checker 32c outputs the value to the Cn value generator 32d. Conversely, when the value output from the adder 32b does not fall within the specified range, the range checker 32c outputs a previous value to the Cn value generator 32d. Then, the Cn value generator 32d calculates a Cn value from the value output from the range checker 32c.

The divider 32e divides the Cn value by the number of tributary slots. Then, a quotient and a remainder of the division are output as a Cm value and a Cnd value, respectively. In the embodiment, the number of tributary slots corresponds to the number of virtual slots obtained by dividing the payload area of the OTU frame into a plurality of blocks with a specified size. A configuration that calculates the Cn value, the Cm value, and the Cnd value is described in, for example, Japanese Laid-Open Patent Publication No. 2016-163275.

The description returns to FIG. 4. Here, before the selector 34, the multiplexer 35, the FEC processor 36, and the transmission unit 37 are described, the payload receiver 41, the rate information receiver 42, the frame generator 43, and the mapping unit 44 will be described. In this example, the payload receiver 41, the rate information receiver 42, the frame generator 43, and the mapping unit 44 are implemented by the CPU 40.

The payload receiver 41 receives client data extracted from a client signal in the hardware circuit 30. The payload receiver 41 may include a FIFO memory. In this case, the client data is written in the FIFO memory.

The rate information receiver 42 receives rate information from the hardware circuit 30. The rate information includes a Cn value, a Cm value, and a Cnd value detected by the rate information detector 32. The rate information receiver 42 receives the rate information (Cn value, Cm value, Cnd value) from the hardware circuit 30 in synchronization with the frame pulse.

The frame generator 43 generates an empty frame whenever a frame pulse is received from the hardware circuit 30. Here, an empty frame is not particularly limited, but is an ODUk frame in which data is not written in the payload area in the embodiment. In this case, the frame generator 43 preferably configures overhead (OPU overhead and ODU overhead) information. The overhead information includes a specified fixed value. The overhead information may include a value corresponding to a communication protocol or a communication rate.

The mapping unit 44 generates a transmission frame using the empty frame generated by the frame generator 43. That is, the mapping unit 44 reads the client data from the FIFO memory of the payload receiver 41 and writes the client data in the payload area of the empty frame. At this time, the client data is written in the payload area of the empty frame based on the rate information (for example, the Cm value). Specifically, the client data is written to be evenly arranged in the payload area according to a specified algorithm determined in conformity with a communication standard. In an unused area inside the payload area, a stuff byte is written. Further, the mapping unit 44 writes the Cm value and the Cnd value received from the hardware circuit 30 in a specified area in the overhead of the frame.

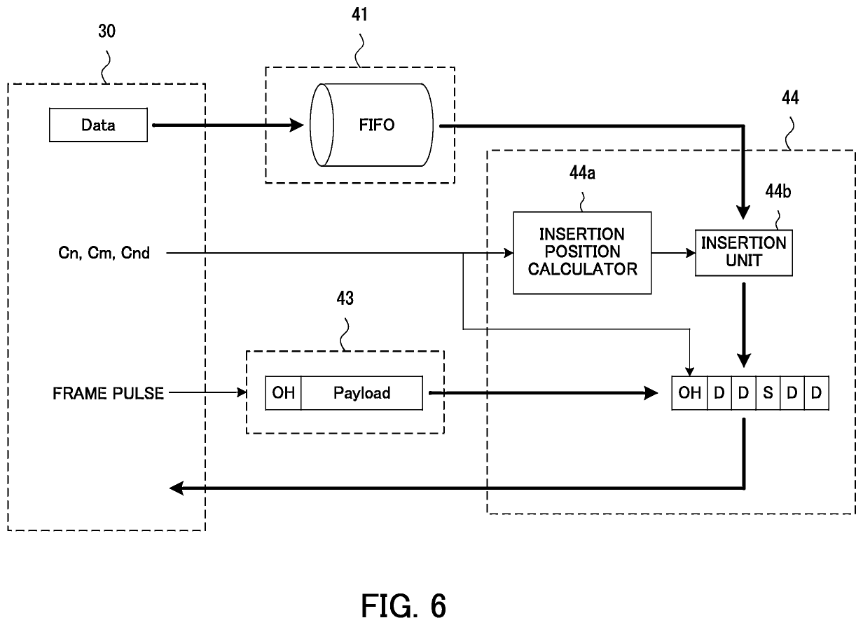

FIG. 6 illustrates an example of a mapping operation by the CPU 40. In the embodiment, a frame pulse is given from the hardware circuit 30 to the CPU 40 at a specified cycle. The client data extracted from the client signal is transmitted from the hardware circuit 30 to the CPU 40 in synchronization with the frame pulse, and is written in the FIFO memory of the payload receiver 41. The client data is written in the payload area of the ODUk frame in the mapping unit 44. In synchronization with the frame pulse, rate information (the Cn value, the Cm value, and the Cnd value) detected by the hardware circuit 30 is transmitted to the CPU 40. Here, the Cm value is an example of data amount information indicating the amount of client data written in the payload area of the ODUk frame.

In the CPU 40, the frame generator 43 generates an empty frame according to the frame pulse received from the hardware circuit 30. Further, the rate information (Cn value, Cm value, Cnd value) is given to the mapping unit 44. Then, the mapping unit 44 reads the client data from the FIFO memory based on the rate information.

The mapping unit 44 includes an insertion position calculator 44a and an insertion unit 44b. The insertion position calculator 44a calculates a position in the payload area into which the client data is to be inserted based on the Cm value. In this process, an insertion position is determined, for example, such that the client data is evenly arranged in the payload area. Then, the insertion unit 44b inserts the client data into the payload area according to a calculation result of the insertion position calculator 44a. The stuff byte is inserted into a free area inside the payload area. In FIG. 6, “OH” indicates an overhead, “D” indicates client data, and “S” indicates a stuff byte.

Thereafter, the mapping unit 44 sets the Cm value and the Cnd value in a specified area inside the overhead. Accordingly, a transmission frame is configured. Then, the transmission frame is transmitted from the CPU 40 to the hardware circuit 30.

The description returns to FIG. 4. In FIG. 4, the optical transmission device 10 can process a plurality of client signals in parallel. In this case, the hardware circuit 30 may include a plurality of reception units 31, and the CPU 40 may include a plurality of mapping units 44. Then, the CPU 40 can generate a plurality of ODU frames in parallel.

When the CPU 40 generates a plurality of ODU frames in parallel, the selector 34 guides the plurality of ODU frames to the multiplexer 35. The multiplexer 35 multiplexes the plurality of ODU frames generated in parallel. That is, an HO ODU frame is generated from a plurality of LO_ODU frames. On the other hand, when the CPU 40 generates one ODU frame for one frame pulse, the selector 34 guides the ODU frame to the FEC processor 36.

The FEC processor 36 adds an error correction code to the ODU frame received from the CPU 40 or the ODU frame output from the multiplexer 35. In this process, the OTU overhead is applied to the ODU frame. Accordingly, an OTN frame is generated as illustrated in FIGS. 3A to 3C. Here, when multiplexing is not performed, an OTUk frame illustrated in FIG. 3B is generated. When n LO_ODU frames are multiplexed, an OTUn frame illustrated in FIG. 3C is generated. I Then, the transmission unit 37 transmits an OTN signal indicating the OTU frame to the network.

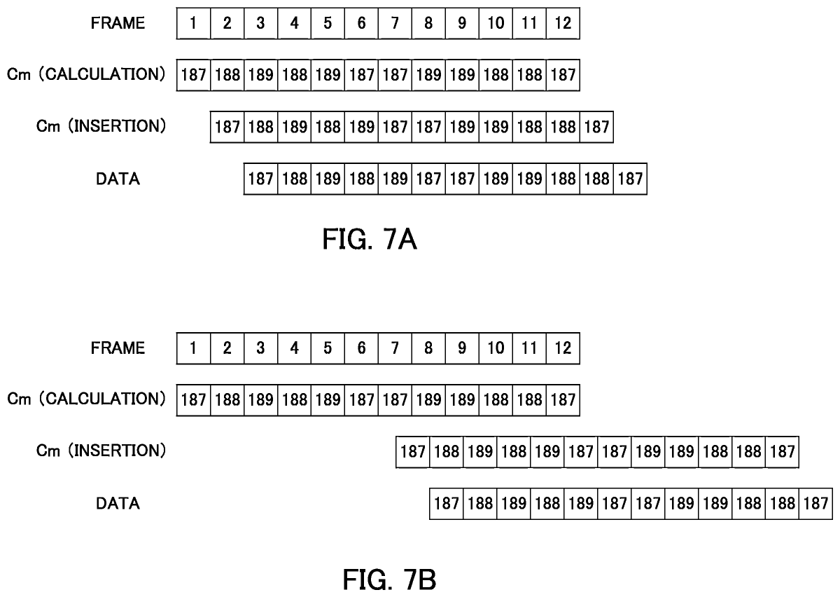

FIGS. 7A and 7B illustrate examples of timing charts of frame generation. FIG. 7A illustrates an example of frame generation in the configuration illustrated in FIG. 2, and FIG. 7B illustrates an example of frame generation in the configuration according to the embodiment of the present disclosure. Values of 187 to 189 represent Cm values.

In the configuration illustrated in FIG. 2, all the processes are performed by a hardware circuit. Therefore, in this case, the operation of calculating the Cm value, the operation of inserting the Cm value into the overhead of the frame, and the operation of storing the client data in the payload area of the frame according to the Cm value are synchronized with each other. In the case illustrated in FIG. 7A, when the Cm value is calculated in a certain frame pulse (for example, Frame 1), the Cm value is inserted into the overhead according to the subsequent frame pulse (in this case, Frame 2), and the client data is stored in the payload area according to the subsequent frame pulse (in this case, Frame 3).

In the configuration according to the embodiment, the Cm value is calculated in the hardware circuit 30, and the CPU 40 receives the Cm value from the hardware circuit 30 and performs the mapping operation. In this process, an operation (that is, an operation of inserting the Cm value into the overhead of the frame and an operation of storing the client data in the payload area of the frame according to the Cm value) of the CPU 40 can be performed at any specified timing with respect to an operation (that is, the operation of calculating the Cm value) of the hardware circuit 30. That is, the operation of the CPU 40 is executed using a frame pulse as a trigger, but is not necessarily executed in synchronization with reception of the frame pulse. Accordingly, the hardware circuit 30 and the CPU 40 can operate independently of each other.

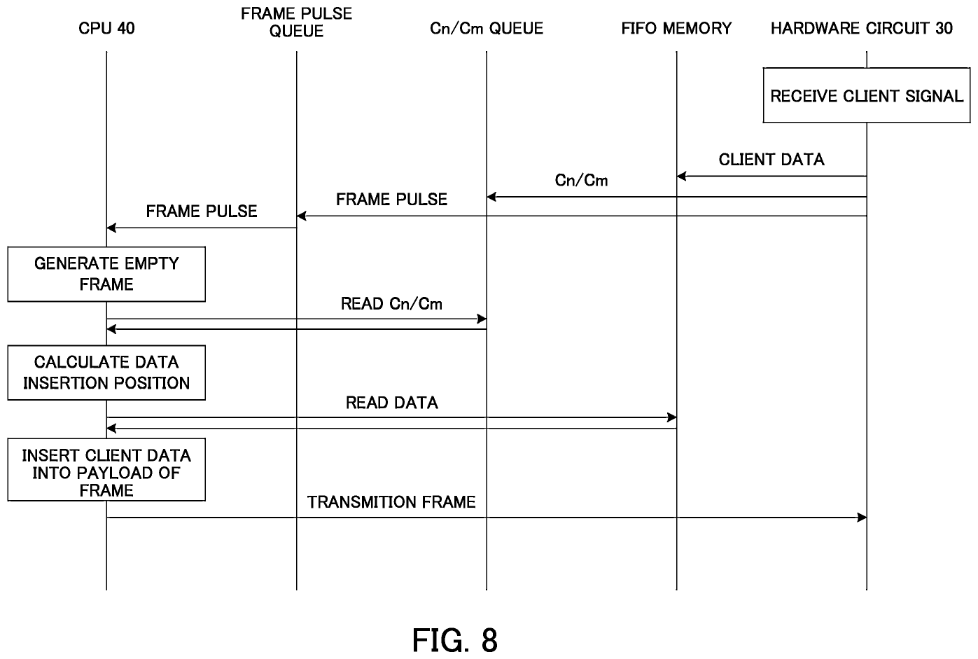

FIG. 8 is a sequence diagram illustrating an example of a procedure of generating an OTN frame for transmitting the client data. In FIG. 8, the CPU 40 corresponds to the frame generator 43 and the mapping unit 44. The FIFO memory is provided in the payload receiver 41 or the mapping unit 44. A Cn/Cm queue corresponds to the rate information receiver 42. A frame pulse queue is provided in the frame generator 43.

The hardware circuit 30 receives the client signal from the client and extracts the client data from the client signal. The extracted client data is written in the FIFO memory. The hardware circuit 30 generates rate information (the Cn value, the Cm value, and the Cnd value) in synchronization with the frame pulse. The rate information (the Cn value, the Cm value, and the Cnd value) is written in the Cn/Cm queue. Further, a frame pulse is given from the hardware circuit 30 to the CPU 40. The frame pulse is written into the frame pulse queue.

When the frame pulse is written in the frame pulse queue, the frame generator 43 in the CPU 40 generates an empty frame. In this process, an overhead of the frame is generated. In the CPU 40, the mapping unit 44 reads the rate information from the Cn/Cm queue. Then, the insertion position calculator 44a calculates the position in the payload area into which the client data is to be inserted based on the rate information (here, the Cm value). A method of calculating a position may be in accordance with an algorithm defined in a communication standard. Further, the mapping unit 44 reads the client data from the FIFO memory. The insertion unit 44b inserts the client data into the payload area of the frame according to the calculation result by the insertion position calculator 44a. In this process, the rate information (here, the Cm value and the Cnd value) is inserted into the overhead of the frame.

The ODU frame generated in this way is transmitted from the CPU 40 to the hardware circuit 30. The hardware circuit 30 generates an OTU frame from the ODU frame and outputs the OTU frame to the network.

As described above, in the optical transmission device 10 according to the embodiment, the software and the hardware circuit cooperate to process the main signal. Here, a process requiring a high-speed operation (a process of detecting Cn/Cm/Cnd, a multiplexing process, and the like) is performed by the hardware circuit 30. Accordingly, communication quality does not deteriorate as compared with the configuration illustrated in FIG. 2. The process (for example, a process of generating an overhead of the OTN frame, and the like) depending on the communication protocol is implemented by software in the CPU 40. Accordingly, even when a communication protocol is added or changed, development of a large-scale circuit is unnecessary, and can be handled by updating the program code and/or the parameter.

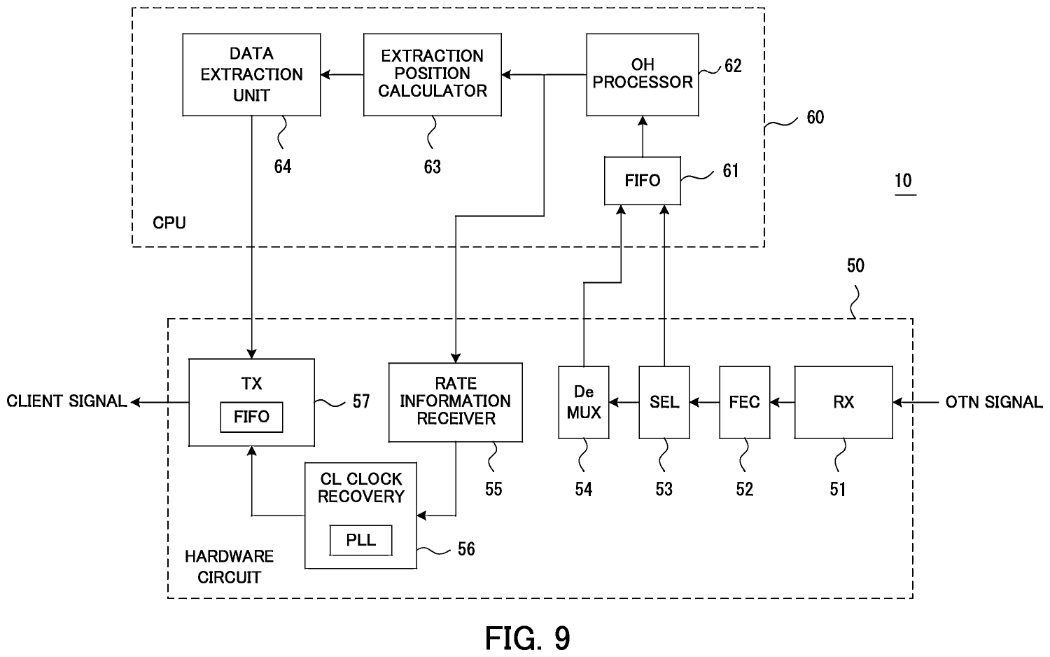

FIG. 9 illustrates an example of a configuration in which the client data is extracted from an OTN signal and transmitted to a destination client in the optical transmission device according to the embodiment. In the embodiment, the optical transmission device 10 includes a reception unit 51, an FEC processor 52, a selector 53, a demultiplexer (DeMUX) 54, a rate information receiver 55, a CL clock recovery 56, a transmission unit 57, a FIFO memory 61, an overhead processor 62, an extraction position calculator 63, and a data extraction unit 64 as a configuration that extracts the client data from the OTN signal and transmits the client data to the client. The optical transmission device 10 may further include other circuits, devices, or functions not illustrated in FIG. 9. For example, in FIG. 9, an optical receiver that receives an optical signal by which the OTN signal propagates and an optical transmitter that generates an optical signal by which the client signal propagates are omitted.

The reception unit 51, the FEC processor 52, the selector 53, the demultiplexer 54, the rate information receiver 55, the CL clock recovery 56, and the transmission unit 57 are implemented by a hardware circuit 50. The hardware circuit 50 is implemented by, for example, an FPGA.

The reception unit 51 receives an OTN signal transmitted from another optical transmission device (In FIG. 1, an optical transmission device 10B). The OTN signal transmits an OTN frame. The reception unit 51 terminates the OTN signal and extracts an OTU frame from the OTN signal. In this process, the reception unit 51 can extract the NW clock from the received OTN signal.

The FEC processor 52 executes an error correction process using the error correction code assigned to the received frame. The selector 53 determines whether a plurality of ODU frames are stored in the received frame. When only one ODU frame is stored in the received frame, the selector 53 guides the ODU frame to the CPU 60. On the other hand, when a plurality of ODU frames are stored in the received frame, the selector 53 guides the received frame to the demultiplexer 54. The demultiplexer 54 extracts a plurality of ODU frames from the received frame and guides the plurality of ODU frames to the CPU 60.

Here, before the rate information receiver 55, the CL clock recovery 56, and the transmission unit 57, the FIFO memory 61 are described, the overhead processor 62, the extraction position calculator 63, and the data extraction unit 64 will be described. In this example, the FIFO memory 61, the overhead processor 62, the extraction position calculator 63, and the data extraction unit 64 are implemented by the CPU 60.

The CPU 40 illustrated in FIG. 4 and the CPU 60 illustrated in FIG. 9 may be physically independent devices. Alternatively, the CPU 40 illustrated in FIG. 4 and the CPU 60 illustrated in FIG. 9 may be implemented by one general-purpose processor.

The ODU frame extracted from the received OTN signal in the hardware circuit 50 is written in the FIFO memory 61. The overhead processor 62 processes the overhead of the ODU frame written in the FIFO memory 61. In this process, the overhead processor 62 extracts the rate information (the Cm value and the Cnd value) from the overhead. The overhead processor 62 calculates the Cn value from the extracted Cm value and Cnd value. Further, the overhead processor 62 transmits the Cn value, the Cm value, and the Cnd value to the hardware circuit 50. The overhead processor 62 may execute alarm processing based on information stored as the overhead.

The extraction position calculator 63 calculates a position at which the client data is inserted in the payload area of the received frame based on the Cm value extracted from the received frame by the overhead processor 62. A calculation method is substantially the same as the algorithm used by the insertion position calculator 44a illustrated in FIG. 6.

The data extraction unit 64 extracts the client data from the payload area of the received frame according to a calculation result by the extraction position calculator 63. The client data extracted by the data extraction unit 64 is transmitted to the hardware circuit 50 to be written in the FIFO memory of the transmission unit 57.

The rate information receiver 55 receives the rate information (the Cn value, the Cm value, and the Cnd value) from the CPU 60. The CL clock recovery 56 includes, for example, a digital phase locked loop (PLL) circuit, and generates an output clock based on the NW clock, the Cn value, and the Cm value reproduced by the reception unit 51. In this process, the CL clock recovery 56 calculates the amount of data in the payload area of the frame based on the Cn value and the Cm value. The CL clock recovery 56 calculates a frequency of a reference clock based on the calculated data amount and the frequency of the NW clock. The digital PLL circuit adjusts a frequency of the output clock through feedback control such that a difference between the frequency of the output clock and the frequency of the reference clock becomes small. Accordingly, the CL clock is reproduced. A configuration that reproduces a clock using a digital PLL is described in, for example, Japanese Patent Application Laid-Open No. 2016-163275.

The client data extracted from the received frame by the CPU 60 is written in the FIFO memory of the transmission unit 57. The transmission unit 57 reads the client data from the FIFO memory using the CL clock reproduced by the CL clock recovery 56, and transmits the client data to the destination client.

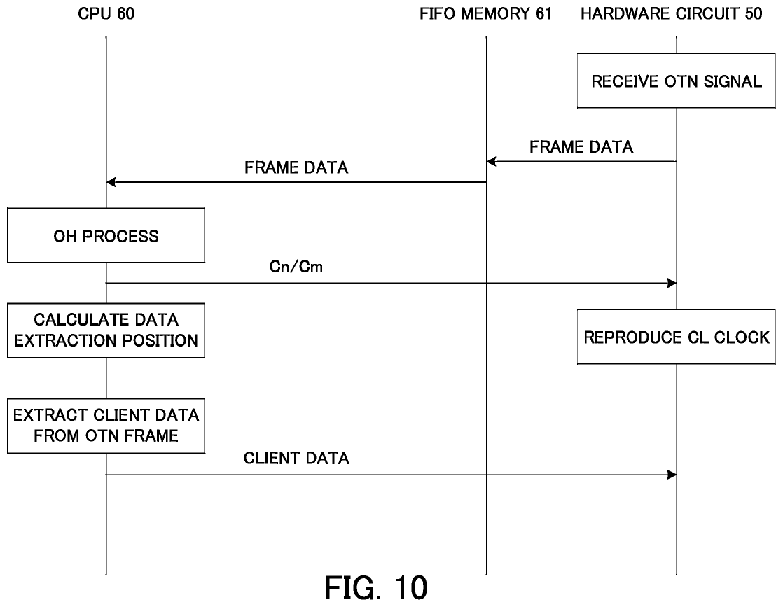

FIG. 10 is a sequence diagram illustrating an example of a procedure of extracting the client data from the OTN frame. In FIG. 10, the CPU 60 corresponds to the overhead processor 62, the extraction position calculator 63, and the data extraction unit 64.

The hardware circuit 50 receives an OTN signal from another optical transmission device (In FIG. 1, an optical transmission device 10B) via a network. The hardware circuit 50 extracts an OTN frame from the received OTN signal and performs an error correction process. Then, the hardware circuit 50 extracts the frame data indicating an ODU frame from the OTN frame and transmits the frame data to the CPU 60. The frame data is written in the FIFO memory 61.

The CPU 60 reads the frame data from the FIFO memory 61. That is, the CPU 60 acquires an ODU frame transmitted from another optical transmission device.

In the CPU 60, the overhead processor 62 processes the overhead of the received ODU frame. In this process, the overhead processor 62 extracts the Cm value and the Cnd value from the overhead, and calculates the Cn value based on the extracted Cm value and Cnd value. The overhead processor 62 transmits the Cn value, the Cm value, and the Cnd value to the hardware circuit 50. Further, the overhead processor 62 may execute alarm processing based on information stored in the overhead.

Subsequently, in the CPU 60, the extraction position calculator 63 calculates a data insertion position in the payload area. Specifically, the extraction position calculator 63 calculates a position at which the client data is stored in the payload area of the received frame based on the Cm value extracted from the received frame by the overhead processor 62.

Further, in the CPU 60, the data extraction unit 64 extracts the client data from the received frame. In this process, the data extraction unit 64 extracts the client data from the payload area of the received frame according to the extraction position calculated by the extraction position calculator 63. Thereafter, the client data extracted by the data extraction unit 64 is transmitted to the hardware circuit 50 and written in the FIFO memory of the transmission unit 57.

The hardware circuit 50 reproduces the CL clock using the Cn value, the Cm value, and the Cnd value notified from the CPU 60. Then, the hardware circuit 50 transmits the client data written in the FIFO memory of the transmission unit 57 to the destination client using the reproduced CL clock.

As described above, in the optical transmission device 10 according to the embodiment, the software and the hardware circuit cooperate to process the main signal. Here, a process requiring a high-speed operation (such as a process of reproducing the CL clock from the NW clock) is performed by the hardware circuit 50. Accordingly, communication quality does not deteriorate as compared with the configuration illustrated in FIG. 2. The process (for example, a process of the overhead of a received OTN frame, and the like) depending on the communication protocol is implemented by software in the CPU 60. Accordingly, even when a communication protocol is added or changed, development of a large-scale circuit is unnecessary, and can be handled by updating the program code and/or the parameter.

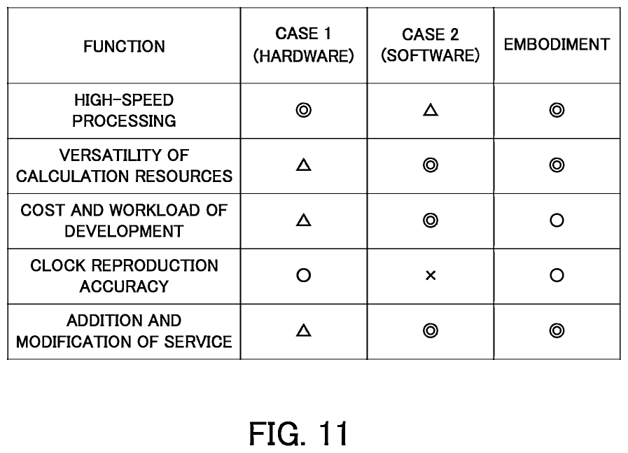

FIG. 11 is a diagram illustrating advantages according to the embodiment of the present disclosure. Here, Cases 1 and 2 are compared with the embodiment. In Case 1, as illustrated in FIG. 2, all the processes of the main signal are implemented by a hardware circuit. In Case 2, all the processes of the main signal are implemented by software.

In the embodiment of the present disclosure, a process requiring a high-speed operation is implemented by a hardware circuit. Accordingly, it is possible to obtain a high-speed operation and accuracy of clock reproduction equivalent to those in Case 1.

In the embodiment of the present disclosure, the main signal is processed by software and a hardware circuit in cooperation. Here, the degree of abstraction of software is higher than that of a hardware circuit such as an FPGA. Therefore, versatility of calculation resources, cost and workload of development, and addition and modification of communication services are improved with respect to Case 1, and advantages equivalent to Case 2 are obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission device comprising:
a reception unit configured to receive a first signal transmitted based on a first clock;
a detector configured to detect rate information for storing client data in the first signal in a transmission frame based on the first signal;
a mapping unit configured to generate the transmission frame by mapping the client data to a payload area of the transmission frame based on the rate information; and
a transmission unit configured to output the transmission frame or a second transmission frame including the transmission frame to a network, wherein
the reception unit, the detector, and the transmission unit are implemented by a hardware circuit, and the mapping unit is implemented by software processing using a processor.

2. The optical transmission device according to claim 1, further comprising:
an FEC processor configured to generate the second transmission frame by adding an error correction code to the transmission frame, wherein
the FEC processor unit is implemented by the hardware circuit.

3. The optical transmission device according to claim 1, wherein
the rate information includes data amount information indicating an amount of client data stored in the payload area.

4. The optical transmission device according to claim 3, wherein
the mapping unit includes
a position calculator that calculates a position in the payload area into which the client data is inserted based on the data amount information, and
an insertion unit that inserts the client data into the payload area in accordance with a calculation result of the position calculator.

5. The optical transmission device according to claim 1, further comprising:
a multiplexer configured to multiplex a plurality of frames, wherein
the reception unit receives a plurality of the first signals,
the mapping unit generates a plurality of the transmission frames based on the plurality of first signals,
the multiplexer multiplexes the plurality of transmission frames to generate the second transmission frame, and
the multiplexer is implemented by the hardware circuit.

6. An optical transmission device comprising:
a reception unit configured to receive a frame transmitted based on a second clock;
an overhead processor configured to extract, from an overhead of the frame, rate information used to store client data in a payload area of the frame in a remote station device;
a data extraction unit configured to extract the client data from the payload area of the frame based on the rate information;
a clock recovery configured to reproduce a first clock for transmitting the client data to a destination based on the rate information; and
a transmission unit configured to transmit the client data extracted by the data extraction unit to the destination based on the first clock,
wherein the reception unit, the clock recovery, and the transmission unit are implemented by a hardware circuit, and the overhead processor and the data extraction unit are implemented by software processing using a processor.

7. The optical transmission device according to claim 6, further comprising:
an FEC processor configured to perform an error correction process using an error correction code assigned to the frame, wherein
the FEC processor is implemented by the hardware circuit.

8. The optical transmission device according to claim 6, wherein
the rate information includes data amount information indicating an amount of client data stored in the payload area.

9. The optical transmission device according to claim 8, further comprising:
a position calculator configured to calculate a position at which the client data is stored in a payload area of the frame based on the data amount information, wherein
the data extraction unit extracts the client data from the payload area according to a calculation result of the position calculator.
